(19) United States
(12) Patent Application Publication
(10) Pub. No.: US 2014/0053449 A1
(43) Pub. Date: Feb. 27, 2014

(54) Fishing Float Apparatus

(71) Applicant: Bob Martin, Checotah, OK (US)

(72) Inventor: Bob Martin, Checotah, OK (US)

(21) Appl. No.: 13/593,923

(22) Filed: Aug. 24, 2012

(51) Int. Cl. A01K 97/12

(52) U.S. Cl. CPC A01K 97/12
USPC 43/17

(57) ABSTRACT

A fishing float apparatus comprising: a frame; a float means for buoyantly supporting the apparatus; a reel means for alternately extending and retrieving fishing line; lock means for preventing the spool means from moving when the reel means is in a deployed configuration; a mechanical catch indicator means for notifying an operator of whether a fish has been caught; whereby, the float means can be deployed with at least one fishing hook attached to the line at a desired depth and, without being actively monitored, can be visually checked at a later time to determine visually whether at least one fish is on at least one of the hooks and, if so, the fish can be conveniently and quickly reeled in.

### CROSS-REFERENCE TO RELATED APPLICATIONS

None.

### SUMMARY OF THE INVENTION

A fishing float apparatus comprising: a frame; a float means for buoyantly supporting the apparatus; a reel means for alternately extending and retrieving fishing line, the reel means including a feature allowing a fisher to easily grip the apparatus while deploying or retrieving line; lock means for preventing the reel means from moving when the spool means is in a deployed configuration; a mechanical catch indicator means for notifying an operator of whether a fish has been caught; whereby, the float means can be deployed with at least one fishing hook attached to the line at a desired depth and, without being actively monitored, can be visually checked at a later time to determine visually whether at least one fish is on at least one of the hooks and, if so, the fish can be conveniently and quickly reeled in.

Fishing is an ancient human activity. For thousands of years, people have tried to lure fish onto their hooks. Fishers have the option of either actively fishing (casting and reeling) or passively fishing by placing lines to be checked later, rather than being actively monitored. The invention relates to devices that allow a fisher to set one or more hooks, then to depart and check later to see if fish have been caught. These passive means of fishing may be referred to as trotlines, setlines, juglines, limblines, or other regional variations. What they all have in common is a line without a rod attached that need not be held in the hand or closely attended. For convenience, the type of fishing setup discussed above will generically be referenced herein as trotline rigs.

Prior trotline rigs failed to satisfy at least four distinct needs, among others: (1) the need for ease in deploying and retrieving line with one or more hooks affixed and a convenient way to grip the rig while undertaking the task; (2) the ability to float without the need for mounting to a boat or other support; (3) the need to be able to visually determine whether a fish was on the line without lifting the trotline rig out of the water; and (4) simple and inexpensive construction so that they do not malfunction and are inexpensive to purchase. Prior devices satisfied one or more of these needs, but there was not a device that satisfied all of them.

An early device that satisfied the need for flotation and a visual indicator of whether a fish was on the line was disclosed in U.S. Pat. No. 1,410,817 to Lloyd. Lloyd's trotline rig provided a float mechanism and a visual indicator, a type of flag mechanism activated by the tugging force provided by a fish on the line. However, Lloyd's mechanism was quite complicated making it both expensive and subject to malfunction. Further, and more importantly, Lloyd failed to provide an easy means for deploying and retrieving a line.

(007) U.S. Pat. No. 4,453,843 to Martyniuk discloses what is described as a “trot-line reel,” but failed in reality to provide an easy means for deploying or retrieving the line. The “reel” was simply a spool without an accompanying simple mechanism to spin it for retrieval or deployment of line.

A true reel was disclosed by Pugh in U.S. Pat. No. 4,685,243 for a “trotline reel and hook holder.” Pugh also failed to achieve all the necessary elements of an effective trotline rig. There was no easy way to hold the reel while line was being deployed or retrieved. That is, there was no grip point or way for it to be held easily. Further, Pugh provided no flotation means for allowing the device to be deployed away from attachment to a boat or other support means. Pugh also failed to provide any visual indicator that a fish was on the line.

Design Pat. No. 312,294 to Doskocil et al. disclosed a trotline rig that accomplished several of the objectives noted above in that it provided a reel mechanism for easy deployment and retrieval. Doskocil failed to provide any flotation, however, and it did not disclose a visual mechanism for revealing that a fish was on the line.

U.S. Pat. No. 5,048,219 to Georgescu disclosed a trot line with a simple visual indicator of a fish on the line. It flipped over when a fish had been caught. However, it did not provide an easy means of deploying or retrieving line.

All of the foregoing trotline rigs accomplished some of the four primary objectives, but none of them accomplished all of the objectives. The present invention accomplishes all the objectives in a simple, low-cost device that can be sold for a reasonable price allowing fishers to buy and deploy several rigs increasing their chance of success.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### DESCRIPTION OF THE DRAWINGS

FIG. 1 is perspective view of an embodiment of the invention with extra flotation configuration shown.

FIG. 2 is a bottom view of an embodiment of the invention.

FIG. 3 is a top view of an embodiment of the invention.

FIG. 4 is a side view of an embodiment of the invention.

FIG. 5 is a detail view of a line catcher.

FIG. 6 is a partial cross-sectional detail view of a tube portion with extra flotation affixed thereto.

FIG. 7 is a perspective view of an embodiment of the invention that has a curved up tube and includes additional features regarding the reel means.

### DETAILED DESCRIPTION OF THE INVENTION

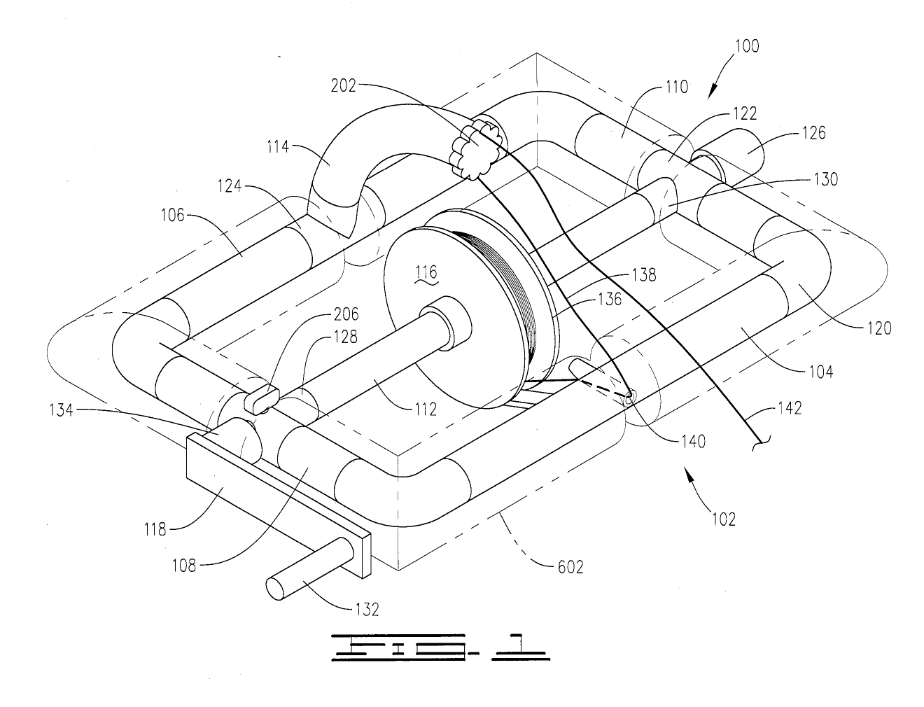

FIG. 1 shows an embodiment of the invention in perspective. The embodiment shown in FIG. 1 has extra flotation added, but this is optional. The invention may float on its own due to the bouyancy of the sealed tubing from which it is preferably constructed.

The fishing float 100 of the present invention includes a main frame 102 shown comprised of a front tube 104, a back tube 106, a first side tube 108 and a second side tube 110. As shown, the main frame 102 is a rectangle, but that is not required. It could be oval, circular, or even triangular or some other non-rectangle shape. The important feature of the main frame 102 is that it is composed of tubing members that provide a stable flotation plane to which the other components of the invention are mounted.

Shown disposed between the first 108 and the second side tubes 110 is a spool tube 112 to which a spool 116 is shown attached. The spool tube 112 rotatingly passes through a first and second bushing 128 and 130. At one end of the spool tube 112 a handle 118 is affixed at aa handle connection 134, and a cap 126 is affixed to another end. The handle 118 is shown with a grip 132, which may be fixedly or rotatingly attached to the handle 118.

In conjunction, the foregoing components comprise a simple reel that facilitates the deployment and retraction of the line 138. The reel means may include gears that allow faster retrieval of the line 138, such as the type of mechanism shown and described in U.S. Pat. No. 4,390,147 to Zuckerman, and incorporated herein by reference. A fisher can easily grip the invention along the second side tube 110 near its intersection with the front tube 104 and allow the second side tube 110 to be cradled in his forearm. This provides an ease of grip for a fisher in deploying or retrieving line.

The spool 116 defines a line basket 136 therein for receiving line 138. The line 138 passes from the spool 116 through a guide 140. A curved up tube 114 extends upwardly from an up tee 124, which is shown mounted in the back tube 106. The curved up tube 114 terminates in an upright cap 200. Mounted to the upright cap 200 is a line catcher 202. The line catcher 202 is adapted to serve as a secure connection point for line 138. In a deployed configuration, a hook line portion 142 extends outwardly from the line catcher 202. In this deployed configuration, a spool lock knob 206 is in a locked position, either deployed through a hole in the spool tube 112 or, as shown in the figures, frictionally engaging the spool tube using threads to cause engagement.

The tubes 104, 106, 108 and 110 may preferably be hollow and thereby provide flotation for the main frame 102. In addition, or in the alternative, a float tube 602 may be affixed to the tubes or otherwise encircle them.

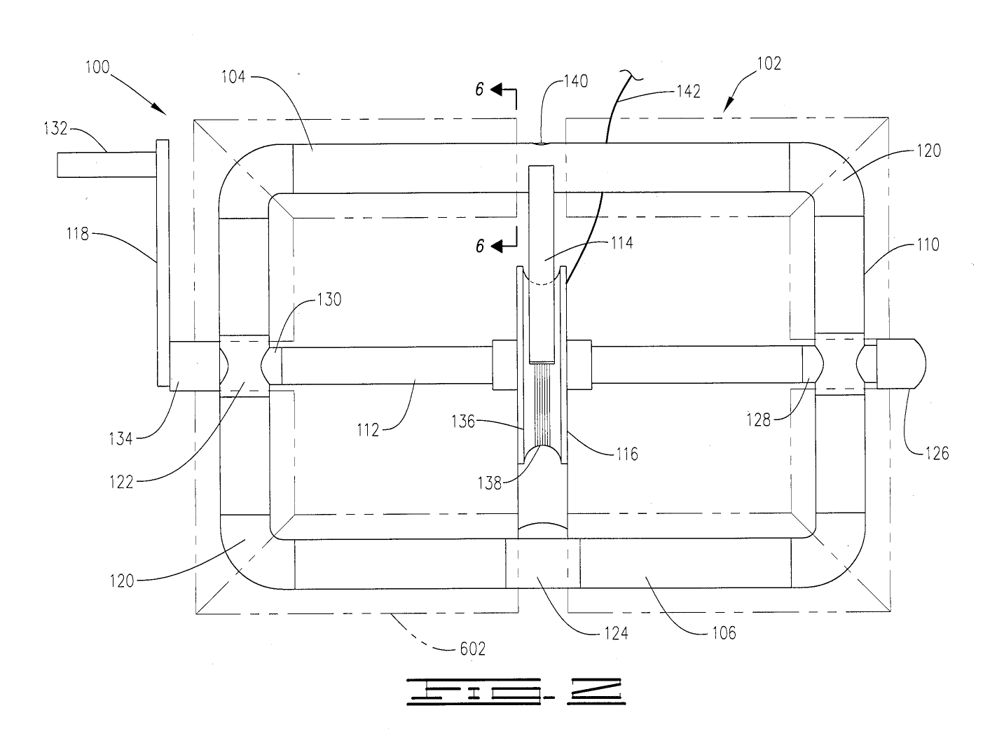

FIG. 2 is a bottom view of an embodiment of the fishing float 100. It shows more detail about the main frame 102. The front tube 104 is shown attached to the second side tube 110 via a corner 120. A tee 122 is shown coordinating the second side tube 110 with the spool tube 112. The spool tube 112 rotatingly passes through the second bushing 130. The cap 126 retains the spool tube 112, and prevents it passing back through the second bushing 130. An underside view of the up tee 124 can be seen at a point along the back tube 106. Also seen is the guide 140 defined in the front tube 104 through which the line 138 passes.

A line guide 114, which extends from the front tube 104 to a point adjacent to the line basket 136. The line guide 114 is preferably substantially planar, and it provides a guide for line 138 as it is reeled onto the line basket 136 and retains tension on the line. The line feed tube 140 serves to guide the motion of the line in operation of the reel means.

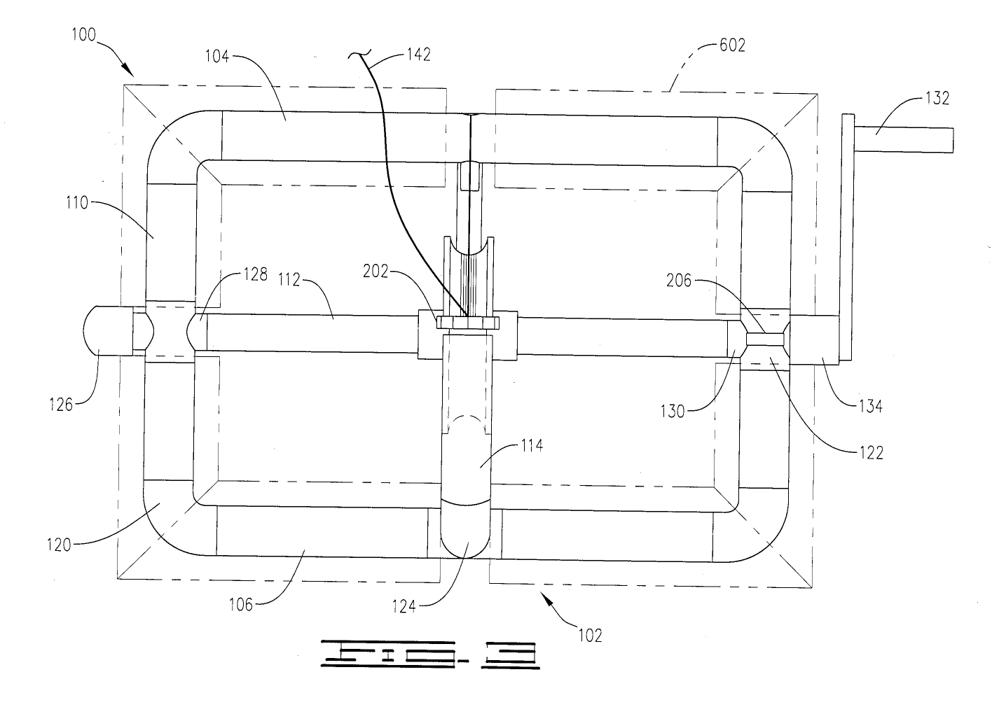

FIG. 3 is a top view of an embodiment of the fishing float 100. The curved up tube 114 can be seen extending up from below. The curved up tube 114 terminates in the line catcher 202. In the deployed configuration shown, the hook line portion 142 extends outwardly from the line catcher 202. The spool lock knob 206 is shown.

FIG. 4 is a side view of an embodiment of the fishing float 100. The device is shown in a locked configuration with the line 138 passing from the spool 116 through the guide 140 and on to the line catcher 202. From there, the hook line portion 142 extends out. To retain the spool in position, the spool lock knob 206 is gripped and turned to engage a spool lock threaded portion in frictional contact with the spool tube 112. The relationship of the up tee 124 to the curved up tube 114 and the line catcher 202 fastened thereto via the post 500 can be seen. An optional flag pole with a flag at its terminal end may provide additional visual indicators that at least one fish is on a hook.

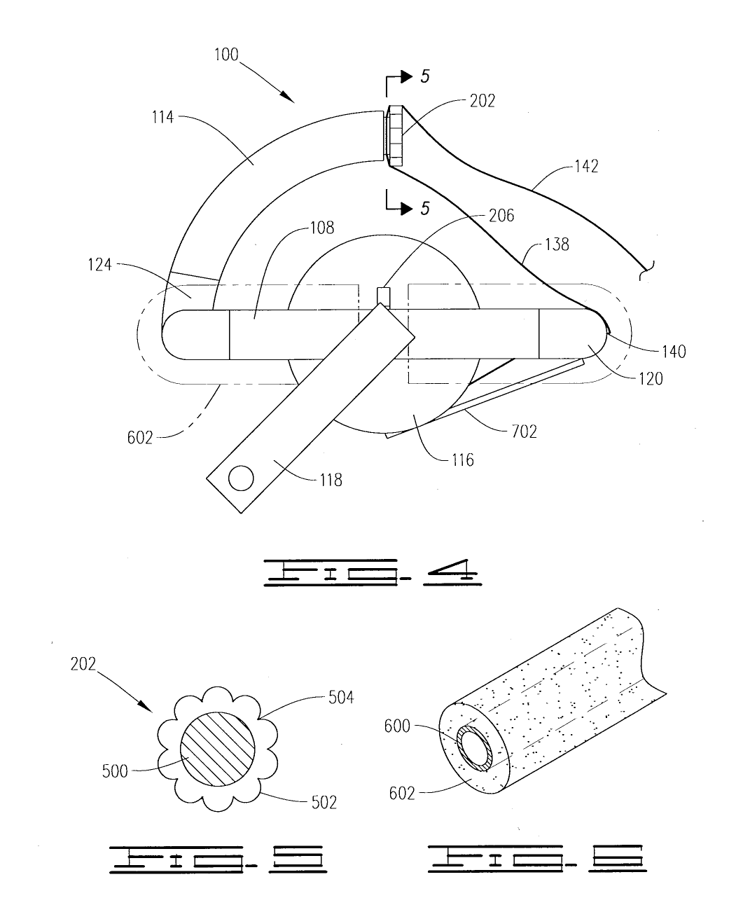

FIG. 5 is a detail partial cross sectional view of the line catcher 202. The post 500 by which the catcher 202 is affixed to the curved up tube 114 is shown in cross section. Between petals 502 are defined a plurality of catcher vees 504. The catcher vees 504 narrow down to a slit adapted to frictionally receive line 138 to retain it in place. In operation, a fisher will, to deploy one or more hooks, wrap the line 138 around the post 500 at least once, then pass the line 138 through at least one of the catcher vees 504.

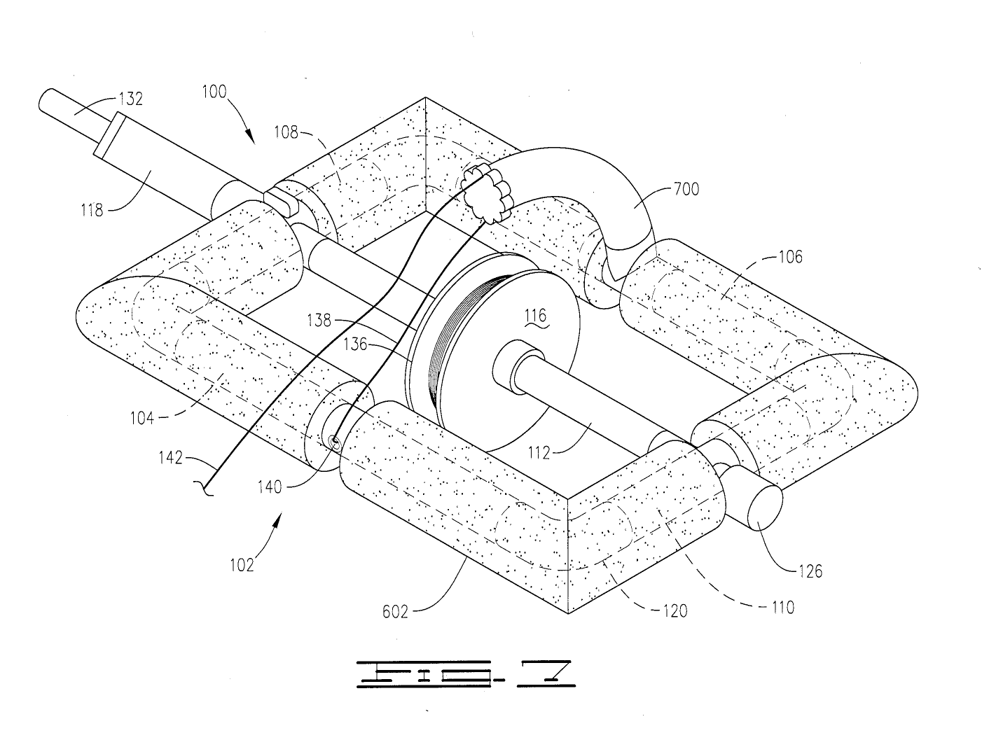

FIG. 6 is a detail cross sectional view of a tube 600 with a float tube 602 affixed thereto. The float tube may define a split therein to allow it to be slipped around the tube 600. The provision of the float tube 602 for additional flotation is an optional configuration. Preferably, the sealed tubes comprising the main frame 102 provide sufficient flotation so that float tubes 602 are not required.

The purpose of the abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

The embodiment as shown in FIG. 7 is generally the preferred embodiment.

While the invention has been shown, illustrated, described and disclosed in terms of specific embodiments or modifications, the scope of the invention should not be deemed to be limited by the precise embodiment or modification therein shown, illustrated, described or disclosed. Such other embodiments or modifications are intended to be reserved especially as they fall within the scope of the claims herein appended.

Having thus described the invention, I claim:

1. A fishing float apparatus comprising:
a. a frame;
b. a float means for buoyantly supporting the apparatus;
c. a reel means for alternately extending and retrieving fishing line and for providing a fisher with a grab point to hold the apparatus while deploying or retrieving line;
d. lock means for preventing the spool means from moving when the reel means is in a deployed configuration;
e. a mechanical catch indicator means for notifying an operator of whether a fish has been caught;
whereby, the float means can be deployed with at least one fishing hook attached to the line at a desired depth and, without being actively monitored, can be visually checked at a later time to determine visually whether at least one fish is on at least one of the hooks and, if so, the fish can be conveniently and quickly reeled in.

2. The apparatus of claim 1 where the frame is comprised of four sealed tubes forming a rectangle, and the sealed tubes comprising the float means.

3. The apparatus of claim 1, an up tube extending above a top side of the frame from one member of the frame, and further comprising a line catcher at a terminal end of the up tube, the line catcher is adapted to serve as an affixation point to which line can be securely attached, and the distance of the line catcher above the platform providing a lever arm through which the force of a fish on the line can flip the platform from a normal deployed position to an upside-down position indicating a fish is on the hook.

4. The apparatus of claim 3 further including a flag pole with a flag affixed to and projecting out from a bottom side of the frame whereby when the apparatus is flipped by a fish on a hook, the flag provides a further visual clue that a fish is on the hook.

5. The apparatus of claim 1 father having float tube affixed to at least one of the tubes comprising the main frame.

6. The apparatus of claim 1, the lock means comprising a screw with a handle affixed and a terminal end adapted to screwed into frictionally engage the spool tube, whereby, in frictional engagement, contact with the screw prevents the spool tube from rotating.

7. The apparatus of claim 1, the real means further including gear means for spinning the spool at a revolution rate faster than the revolution rate of the handle.

8. The apparatus of claim 1, the real means including a line guide adapted to retain tension on the line as it is reeled onto the spool and to guide it along a proper path.
